(19) United States
(12) Patent Application Publication
(10) Pub. No.: US 2018/0257210 A1
(43) Pub. Date: Sep. 13, 2018

(54) HAMMER SOCKET

(71) Applicant: Brim & Hickson, LLC, McKinney, TX (US)

(72) Inventors: Nancy Preston, McKinney, TX (US); Arthur Lloyd Brim, McKinney, TX (US)

(21) Appl. No.: 15/912,217

(22) Filed: Mar. 5, 2018

Related U.S. Application Data
(60) Provisional application No. 62/467,990, filed on Mar. 7, 2017.

(51) Int. Cl. B25C 3/00

(52) U.S. Cl. CPC B25C 3/008

(57) ABSTRACT

Aspects of the disclosure relate to a hammer socket including an adaptor cavity configured to be attached to another tool and a strike plate providing a surface to strike an object. The hammer socket includes a cylindrical body having a base on one end face thereof and a cylindrical head on the other end face thereof. The adaptor cavity extends into the cylindrical body through a portion of the base and forms a female adaptor configured to receive a male adaptor of the other tool. The cylindrical head is coaxial with the cylindrical body and includes the strike plate on end face of the cylindrical head opposite the base.

### PRIORITY CLAIM

This application claims priority to and the benefit of Provisional Patent Application No. 62/467,990 filed in the U.S. Patent and Trademark Office on Mar. 7, 2017, the entire contents of which are incorporated herein by reference as if fully set forth below in their entirety and for all applicable purposes.

### TECHNICAL FIELD

The technology discussed below relates generally to tools including sockets, and in particular, to a hammer tool including a socket.

### INTRODUCTION

A basic hammer, such as a claw hammer, includes a handle and a head connected to the handle. The head includes a neck and a poll with a striking surface on one end thereof. On the other end of the neck is the claw portion, which is typically curved and split down the middle forming a “V” shape. Other types of hammers may include, for example, ball-peen hammers, mallets, sledgehammers and other similar tools with a striking surface and a handle.

The handle provides an area suitable for gripping and enables the user to control the speed of the head with each blow. The length of the handle may be designed as a trade-off between the amount of force that may be transferred on impact and the targeted use and user. A longer handle may deliver a larger force than a smaller handle. However, longer handles may not be practical for all uses and users.

Regardless of the hammer design, the handle increases the weight and overall form-factor of the hammer. In addition, two-piece designs in which the handle and head are attached via a wedge or glue may become unstable, resulting in the hammer head disconnecting from the handle during use. Therefore, designs that separate the handle function from the hammer head, while providing a stable connection during use, may be desirable.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure relate to a hammer socket including an adaptor cavity configured to be attached to another tool and a strike plate providing a surface to strike an object. The hammer socket includes a cylindrical body having a base on one end face thereof and a cylindrical head on the other end face thereof. The adaptor cavity is formed within a portion of the base and extends into an interior of the cylindrical body. Thus, the adaptor cavity forms a female adaptor configured to receive a male adaptor of the other tool. The cylindrical head is coaxial with the cylindrical body and includes the strike plate on end face of the cylindrical head opposite the base.

In some examples, the cylindrical body includes a plurality of holes aligned along a circumference thereof that each extend into the adaptor cavity. In some examples, the cylindrical body includes four holes equidistant from one another along the circumference to secure the hammer socket to a tool containing ball bearings.

In some examples, the cylindrical body and the cylindrical head are formed of single piece of material. In some examples, the material includes a knife-sharpening material such that an external surface of the cylindrical body and the base may each be utilized to sharpen knives.

In some examples, the cylindrical head includes a rim formed of an external surface of the cylindrical head adjoining the strike plate along a circumference thereof to provide an alternate striking surface. In some examples, the cylindrical head further includes a ledge formed of an exposed portion of a second end face of the cylindrical head opposite the strike plate between the rim and the cylindrical body. The ledge may provide a means to pry or provide leverage.

In some examples, the adaptor cavity includes a rounded rectangular opening within the base that is tapered along at least one interior surface of the cylindrical body towards a curvilinear surface opposite the rounded rectangular opening. In some examples, the adaptor cavity includes a width less than a diameter of the base and a length less than a height of the cylindrical body. For example, the length of the adaptor cavity may be less than half of the height of the cylindrical body. In addition, the adaptor cavity may be adjustable.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a perspective view of a hammer socket according to some aspects of the present disclosure.

FIG. 2 is a back view of the hammer socket according to some aspects of the present disclosure.

FIG. 3 is a front view of the hammer socket according to some aspects of the present disclosure.

FIG. 4 is an isometric view of the hammer socket according to some aspects of the present disclosure.

FIG. 5 is a cross-sectional view of the hammer socket according to some aspects of the present disclosure.

FIG. 6 is a perspective view of an adjustable hammer socket according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

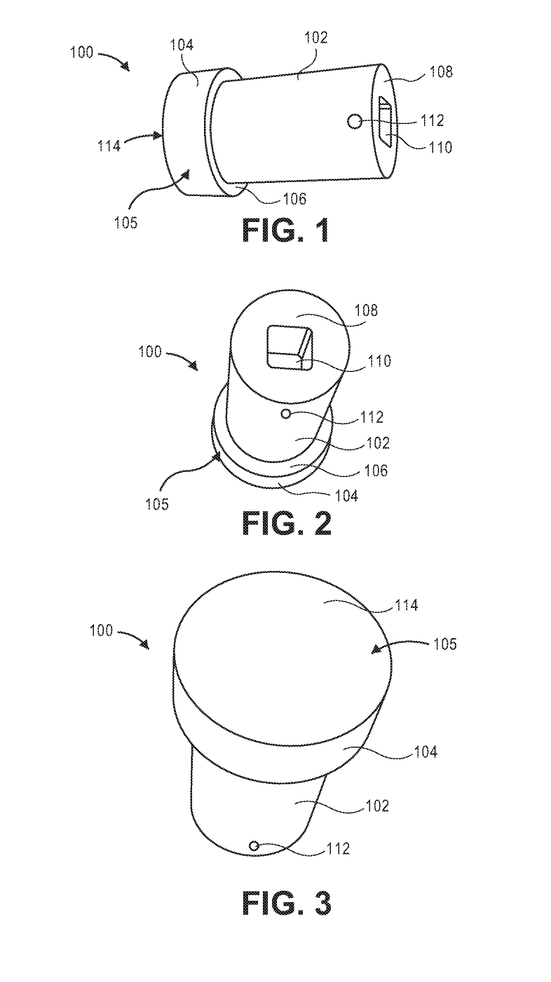

FIG. 1 is a perspective view of a hammer socket 100 according to some aspects of the present disclosure. The hammer socket 100 includes a cylindrical body 102 and a cylindrical head 105 that is coaxial with the cylindrical body 102. The cylindrical head 105 is coupled to the cylindrical body 102 at one end of the cylindrical body 102. An end face on the other end of the cylindrical body corresponds to a base 108 of the hammer socket that enables stabilization of the socket while resting on a surface when not in use.

An end face of the cylindrical head 105 forms a strike plate 114 that provides a surface to strike or hammer objects, including, but not limited to, nails, chisels, punches, and stakes. The cylindrical head 105 further includes a rim 106 corresponding to an external surface of the cylindrical head 105 adjoining the strike plate 114 along a circumference of the strike plate 114. In some examples, the rim 104 may provide an alternate striking surface. The cylindrical head 105 further includes a ledge 106 at the other end of the cylindrical head 105 opposite the strike plate 114. The ledge 106 corresponds to an exposed area of the end face of the cylindrical head 105 opposite the strike plate 114 between the rim 104 and the cylindrical body 102. In some examples, the ledge may be utilized as a means to pry or provide leverage.

The cylindrical body 102 further includes an adaptor cavity 110 formed within a portion of the base 108 that extends into an interior of the cylindrical body 102. The adaptor cavity 110 corresponds to a female adaptor configured to receive a male adaptor of another tool, including, but not limited to, a chisel, ratchet, wrench, punch, or multi-tool. The cylindrical body 102 may further include one or more holes 112 extending through the external surface of the cylindrical body 102 and into the adaptor cavity 110. In some examples, the cylindrical body 102 may include a plurality of holes 112 aligned along a circumference of the cylindrical body 102. For example, the cylindrical body 102 may include four holes 112 equidistant from one another along the circumference thereof. The holes 112 may enable the hammer socket 102 to be secured to a tool containing ball bearings. By attaching the hammer socket 100 to another tool via the adaptor cavity 110 (and optionally, the holes 112), the attached tool may be utilized as a handle to enable a user to transfer sufficient force to the strike plate 114 to strike or hammer a desired object. However, since the hammer socket 100 does not include an attached handle, the weight and form-factor of the hammer socket 100 may be reduced in comparison to other available hammers.

In some examples, the cylindrical body 102 and cylindrical head 105 may be formed of a single piece of material. For example, the cylindrical body 102 and cylindrical head 105 may be collectively formed utilizing a mold of the single piece of material. In some examples, the material may be a knife-sharpening material, such as stainless steel or other material that may be used to sharpen knives. Thus, both the cylindrical body 102 and base 104 may be utilized to sharpen knives. In other examples, the material may be any hard material suitable for striking an object.

FIG. 2 is a back view of the hammer socket 100 illustrating an example of the adaptor cavity 110 having a rounded rectangular shape according to some aspects of the disclosure. The adaptor cavity 110 may be formed within the base 108 such that an axis of the adaptor cavity 110 aligns with the axis of the cylindrical body 102. In addition, the adaptor cavity 110 may have a width less than the diameter of the base 108 and a length (depth) less than the height of the cylindrical body 102. The one or more holes 112 may further be spaced apart from the base 108 by a distance less than the length (depth) of the adaptor cavity 110 such that the hole(s) 110 may extend from the outer surface of the cylindrical body 102 to the adaptor cavity 110.

FIG. 3 is a front view of the hammer socket 100 illustrating an example of the strike plate 114 formed on an end face of the cylindrical head 105 according to some aspects of the disclosure. As can be seen in both FIGS. 2 and 3, the diameter of the strike plate 114 is greater than the diameter of the cylindrical base 102, thus forming the ledge 106 shown in FIG. 2. In addition, the height of the cylindrical head 105 (length of the rim 104) is less than the height of the cylindrical base 102 to maximize the transfer of force to the strike plate 114. In the example shown in FIG. 3, the strike plate includes a flat surface with which to strike or hammer an object. However, in other examples, the strike plate 114 may have a rounded surface.

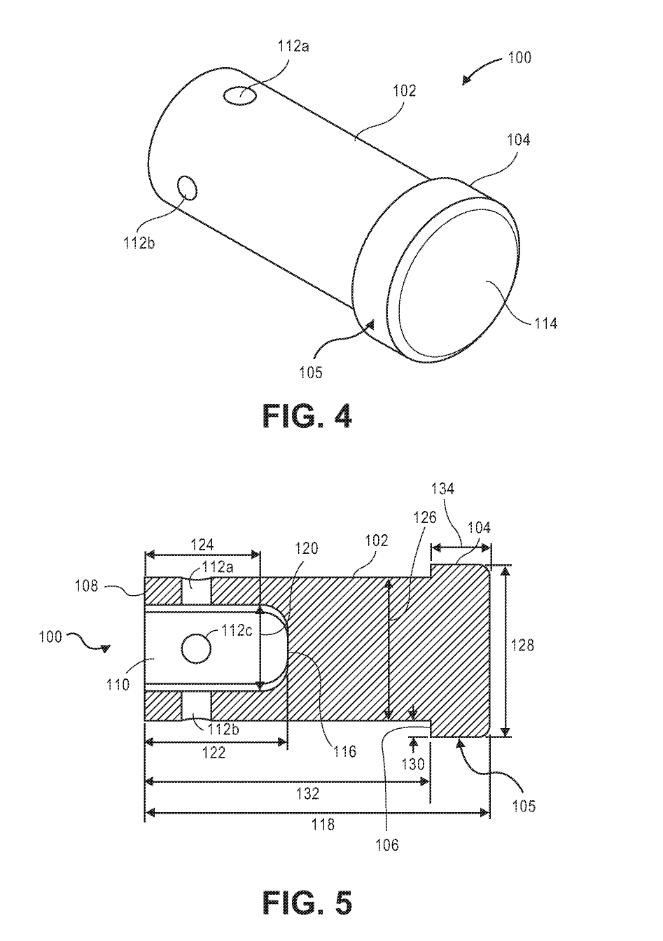

FIG. 4 is an isometric view of the hammer socket 100 according to some aspects of the present disclosure. In the example shown in FIG. 4, the strike plate 114 includes a flat surface with rounded edges along the circumference of the strike plate 114. In addition, multiple holes 112a and 112b are illustrated aligned along the circumference of the external surface of the cylindrical body 102. Although not shown, the cylindrical body 102 may further include two additional holes, each opposite one of the holes 112a or 112b.

FIG. 5 is a cross-sectional view of the hammer socket 100 according to some aspects of the present disclosure. As illustrated in FIG. 5, four holes (three of which 112a, 112b, and 112c are illustrated) extend from the outer surface of the cylindrical body 102 into the adapter cavity 110 and are positioned equidistant from one another along the circumference of the cylindrical body 102. In addition, the adaptor cavity 110 has a rounded rectangular shape that extends through the base 108 into the cylindrical body 102. The adaptor cavity 110 may further be tapered along interior surfaces of the cylindrical body 102 towards a curvilinear surface 116 opposite the rounded rectangular opening in the base 108. In some examples, a width 120 of the adaptor cavity 110 prior to tapering may be approximately 0.375 inches. In addition, a depth (length) 122 of the adaptor cavity 110 may be between 0.55 and 0.625 inches, while a depth (length) 124 of the adaptor cavity 110 from the base 108 to the beginning of the tapered portion may be between 0.4 and 0.5 inches.

A length 118 of the hammer socket 100 may be configurable to produce a desired form-factor of the hammer socket 100. As an example, the length 118 of the hammer socket 100 may be between 1.5 and 2 inches. In this example, a height 132 of the cylindrical body 102 may be between 1.25 and 1.5 inches, while a height 134 of the cylindrical head 105 (length of the rim 104) may be between 0.25 and 0.45 inches. In addition, a diameter 126 of the cylindrical body 102 may be between 0.625 and 01.25, while a diameter 128 of the cylindrical head 105 may be between 0.75 and 01.5. The difference in diameters 126 and 128, respectively, creates the ledge 106, which may have a width of between 0.06 and 0.125 inches. It should be understood that the dimensions of the hammer socket 100 may be variable and are not limited to the particular dimensions discussed herein.

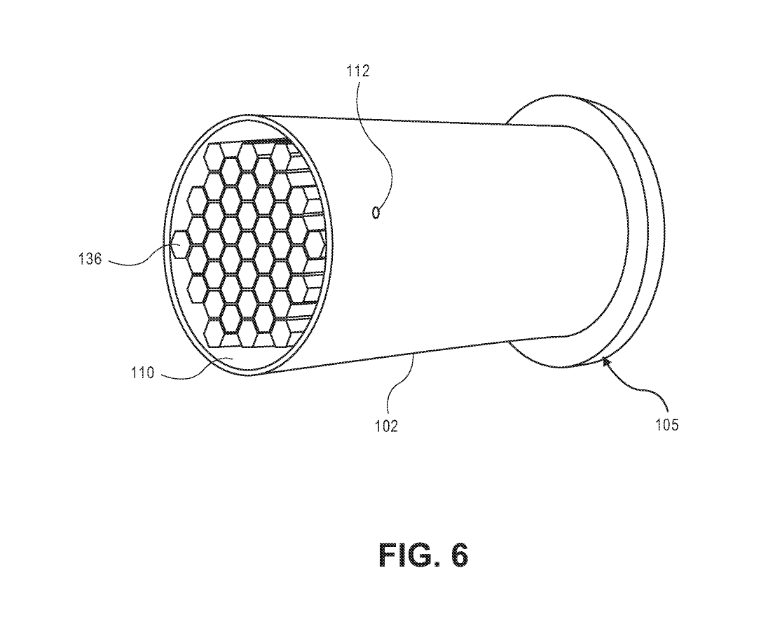

FIG. 6 is a perspective view of an example of an adjustable hammer socket according to some aspects of the present disclosure. In the example shown in FIG. 6, the adaptor cavity 110 is an adjustable cavity including a plurality of pins 136 that may retract to receive male adaptors (drives) of different sizes. For example, the adjustable cavity 110 may be configured to attach to a ⅜″ drive, a ¼″ drive, or a ½″ drive. It should be understood that the adaptor cavity 110 may be made adjustable using any other mechanism, and the disclosure is not limited to utilizing the pins 136 for providing an adjustable cavity.

Several aspects of a hammer socket have been presented with reference to an exemplary implementation. As those skilled in the art will readily appreciate, various aspects described throughout this disclosure may be extended to other configurations of a hammer socket.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A hammer socket, comprising:
a cylindrical body comprising a base and an adaptor cavity formed within a portion of the base and extending into an interior of the cylindrical body, wherein the adaptor cavity comprises a female adaptor configured to receive a male adaptor of a tool; and
a cylindrical head coupled to and coaxial with the cylindrical body, the cylindrical head comprising a strike plate, wherein the strike plate comprises a first end face of the cylindrical head opposite the base.

2. The hammer socket of claim 1, further comprising:
a plurality of holes aligned along a circumference of the cylindrical body, each of the plurality of holes extending into the adaptor cavity.

3. The hammer socket of claim 1, wherein the plurality of holes comprises four holes equidistant from one another along the circumference.

4. The hammer socket of claim 1, wherein the cylindrical body and the cylindrical head comprise a single piece of material.

5. The hammer socket of claim 4, wherein the cylindrical body and the cylindrical head are collectively formed utilizing a mold of the single piece of material.

6. The hammer socket of claim 4, wherein the single piece of material comprises a knife-sharpening material.

7. The hammer socket of claim 1, wherein the cylindrical head further comprises a rim, wherein the rim comprises an external surface of the cylindrical head adjoining the strike plate along a circumference thereof.

8. The hammer socket of claim 7, wherein the cylindrical head further comprises a ledge, wherein the ledge comprises an exposed portion of a second end face of the cylindrical head opposite the first end face between the rim and the cylindrical body.

9. The hammer socket of claim 1, wherein the adaptor cavity comprises a rounded rectangular opening within the base, and wherein the adaptor cavity is tapered along at least one interior surface of the cylindrical body towards a curvilinear surface opposite the rounded rectangular opening.

10. The hammer socket of claim 1, wherein the adaptor cavity comprises a width less than a diameter of the base and a length less than a height of the cylindrical body.

11. The hammer socket of claim 1, wherein the length of the adaptor cavity is less than half of the height of the cylindrical body.

12. The hammer socket of claim 1, wherein the adaptor cavity comprises an adjustable cavity.
